(19) United States
(12) Patent Application Publication
(10) Pub. No.: US 2014/0280334 A1
(43) Pub. Date: Sep. 18, 2014

(54) REPORTING AND ANALYTICS TOOL INTEGRATED WITH CLOUD SERVICE APPLICATIONS

(71) Applicant: Atomic Tower, Inc., South Grafton, MA (US)

(72) Inventor: Brian LeBlanc, South Grafton, MA (US)

(73) Assignee: Atomic Tower, Inc., South Grafton, MA (US)

(21) Appl. No.: 14/203,649

(22) Filed: Mar. 11, 2014

Related U.S. Application Data
(60) Provisional application No. 61/777,396, filed on Mar. 12, 2013.

(51) Int. Cl. G06F 17/30

(52) U.S. Cl. CPC G06F 17/3056
USPC 707/770

(57) ABSTRACT

The present solution is directed to reporting and analytics tools uniquely designed for easy integration with cloud based applications and enterprise applications with on-premise data and easy use by such applications' end users. The present solution provides this functionality as a service to cloud service providers, enabling them to augment their product's capabilities with a reporting and analytics tools that is seamlessly and securely integrated with their product. The present solution is also beneficial as a reporting tool in any market or vertical to enable end users to easily and securely create custom reports. As such, the present solution reduces the skills required for such reports and reduces the delay, time and expense of using specially skilled resources or technical resources to build the custom reports for the end users.

### RELATED APPLICATION

The present applications claims the benefit of and priority to U.S. Provisional Application No. 61/777,396, entitled “Reporting and Analytics Tool Integrated With Cloud Service Applications” and filed on Mar. 12, 2013, which is incorporated herein by reference in its entirety for all purposes.

### FIELD

The present disclosure relates to systems and methods for cloud based reporting tool. In particular, the present disclosure relates to methods and systems for dynamically generating reports from data stored at a cloud service provider.

### BACKGROUND

Enterprise applications and cloud applications store data that is useful to a variety of end users, many of which are not familiar with programming and databases and handling data between programming components and the database. The providers of such applications typically do not build into the design and implementation of the application an easy to use tool for such users to build their own custom reports and to mine such data for their custom reports. Typically such providers consider or include reporting capabilities after the programming and database has been designed and implemented. Although the design of the database and application may be useful to the developers and the functionality of the application, such design may not be useful for reporting by end users not familiar with programming and database schemas. As a result of many application providers adding on reporting capabilities after the application has been implemented, in order to build reports, especially custom reports, significant skill is required in terms of understanding the database schema, the corresponding data and to obtain the data from a database schema designed for the application and not for reporting.

In many cases, a business analyst, manager or other non-technical end user needs to request from and allocate time from technical resources with the required skill in order to create custom reports to obtain the desired data. Instead of getting this information quickly, the end user needs to wait for the custom report to be designed, implemented and tested. If such an end user wants variations or supplemental data for the custom report, the end user needs to ask the technical resources to further create and revise reports until the desired data is obtained. This leads to frustration in the end users using the application to get the information they want in a timely manner. This is further frustrated by the fact that the end user knows what data they want but does not know how to obtain from the application themselves.

Furthermore, application providers are sensitive to giving such end users access to their database and data. Application providers do not want non-technical end users or unauthorized users to make changes to the database, schema or data in order to implement reports. This may impact the operation and performance of the application. As the data in the database may represent confidential and proprietary information of the data owner, application providers do not want this data to be accessed in a manner that would compromise the security of the data. This adds to the challenges of enabling end users to access the data via reporting tools more suitable for their skills.

### BRIEF SUMMARY

The present solution disclosed herein is directed to a next generation of reporting and analytics tools uniquely designed for easy integration with applications, such as a cloud based application, and easy use by such application's end users. Reporting and analytics is a major component of the significant business intelligence (BI) market. The present solution provides this functionality as a service to cloud service providers, enabling them to augment their product's capabilities with a reporting and analytics tools that is seamlessly and securely integrated with their product. By offering the advanced and easy to use report builder with their product, service providers will be better able to service their existing clients and generate new clients as well as enterprises with on-premise data benefit from the easy integration and easy use as well. The present solution is also beneficial as a reporting tool in any market or vertical to enable end users to easily and securely create custom reports. As such, the present solution reduces the skills required for such reports and reduces the delay, time and expense of using specially skilled resources or technical resources to build the custom reports for the end users, including end users of cloud based applications as well as enterprise application with data located within the enterprise (e.g., on-premise data).

The present solution provides multiple inventive aspects directed to the ease of use while maintaining a secure reporting environment that does not impact the integrity, operation and performance of the database. These inventive aspects include but are not limited to the following: i) a secure web service that seamlessly integrates the application environment to the reporting and analytics tool of the present solution, ii) a suggested friendly names engine that helps end users come up with more descriptive and useful names for database fields that may be cryptic and not easy to understand what underlying data they store; (iii) a user interface for easily filtering and grouping data and joining tables that typically requires the user to understand complex structured query language (SQL) expressions; and (iv) a custom view creator that allows user to create views of combination of tables and fields that are not stored in the database but securely and separately with the reporting tool.

In one aspect, the present solution addresses the challenges of security in offering a cloud based reporting tool in accessing sensitive business data in a database remote to the end users. The reporting tool, remote to the application, connects to the data over a network through a secure web service that runs on the application's server. This service uses certificates to validate the connection, accepts SQL to run on the connected database and returns a result set. The service is intentionally lightweight and easy and seamless to install. The service controls and securely proxies SQL requests and responses between the reporting tool and the application's database. As such, the end user of the reporting tool cannot write or implement any SQL or other changes to the database that is not approved or authorized by the service. As the service communicates over a secure connection to the reporting tool the results from an SQL query are communicated securely to the reporting tool. As the reporting tool does not store any of the data locally and accesses the data from the remote database via the service when a report is run, the reporting tool mitigates the risk of and the concern with data being copied or stored outside the database for purposes other than reporting. Even if a user saves a report with filter date, the data may be stored but is stored out of context from the database. As the service controls and limits what SQL queries and database commands that may be run by the reporting the tool, the present solution mitigates the risk of the end user making changes to the database that impacts the operation and performance of the database.

In another aspect, the present solution addresses the challenges of database schema that have field names designed for programming components and developers. The field names in a database may not easily identify or describe the data that is stored in the database. The present solution automatically and intelligently suggests friendly or descriptive names or otherwise aliases for database fields that the user can use for creating reports. Instead of referencing the database field name itself, which may be difficult to parse and recall its underlying data, the present solution allows the end user to reference the more friendly or descriptive name for reports. By using parsing, expression matching and dictionaries, the present solution may automatically suggest friendly or descriptive aliases for each field name in the database. The user may select a suggested friendly name from an enumerated list of friendly names offered by the reporting tool and use the selected friendly name in place of the database field name for creating reports. In some embodiments, the present solution suggests friendly names based on identifying words in the field name of compound words specified via underscores or camel case notation.

In another aspect, the present solution addresses the challenges of filtering and grouping data across different tables that requires complex SQL query languages and editing that end users do not have the required skills. The reporting tool allows users via selectable user interface elements and draggable boxes to make complex groups with multiple filters using “and” and “or” logic between filters. As users create filters and groups of filters for reports, the reporting tool automatically creates the complex SQL query in the background to get the requested data. Without the user interface of the reporting tool, report building would require the user to create and/or edit the complex SQL to use the grouping logic and get the groups as desired.

In another aspect, the present solution addresses the challenges of users who want to create or use their own tables or views of data but do not have access to the database in order to implement such architecture changes. The reporting tool allows an administrator or other user to create their own custom views of their data that do not exist in the application's database. With the custom views of the reporting tool provided by the administrator of the reporting tool, a report writer can create easy to comprehend data entities, such as combination of tables and fields, without having to change the architecture or implementation of the remote database. The remote database stays designed as is and in intact as these custom views are implemented in the report tool to effectively extend the database and application architecture for purposes of reporting.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B-1C are block diagrams depicting embodiments of computers useful in connection with the methods and systems described herein;

FIG. 2 is a block diagram depicting an embodiment of a secure reporting environment;

FIG. 3 is a block diagram depicting embodiments of the web application service configured to dynamically generate reports described herein;

FIG. 4A is a screenshot of a remote connection configuration application management web interface;

FIG. 4B is a screenshot of a custom view creator tool web interface for an application setup step for selecting tables to make available to the user;

FIG. 4C is another screenshot of a user interface for filter creation and grouping for report building;

FIG. 4D is another screenshot of a user interface for field selector for report building;

FIG. 4E is a screenshot of a custom view creator tool web interface;

FIG. 4F is a screenshot of a graphical view of defining relationships between various fields in a database;

FIG. 4G is a screenshot of a custom view creator tool user interface for managing existing custom views;

FIG. 4H is a screenshot of a web service security tool user interface for managing users authorized to access the application is a screenshot of a suggested friendly name tool user interface; and

FIG. 4I is a screenshot of a suggested friendly name tool user interface.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

For purposes of reading the description of the various embodiments below, the following enumeration of the sections of the specification and their respective contents may be helpful:
Section A describes a network and computing environment which may be useful for practicing embodiments described herein; and
Section B describes embodiments of a next generation reporting and analytics tool uniquely designed for easy integration with applications, such as cloud based application, and easy use by such application's end users.
Section C describes one aspect of a reporting and analytics tool relating to a secure web service that seamlessly integrates the application environment to the reporting and analytics tool.
Section D describes another aspect of a reporting and analytics tool relating to a suggested friendly names engine that helps end users come up with more descriptive and useful names for database fields.
Section E describes another aspect of a reporting and analytics tool relating to a user interface for easily filtering and grouping data and joining tables that typically requires the user to understand complex structured query language (SQL) expression.
Section F describes yet another aspect of a reporting and analytics tool relating to a custom view creator that allows user to create views of combination of tables and fields that are not stored in the database but securely and separately with the reporting tool.

### A. Network and Computing Environment

Prior to discussing the specifics of embodiments of the systems and methods, it may be helpful to discuss the network and computing environments in which such embodiments may be deployed, including a description of components and features suitable for use in the present systems and methods. FIG. 1A illustrates one embodiment of a computing environment 101 that includes one or more client machines 102A-102N (generally referred to herein as “client machine(s) 102”) in communication with one or more servers 106A-106N (generally referred to herein as “server(s) 106”). Installed in between the client machine(s) 102 and server(s) 106 is a network.

In one embodiment, the computing environment 101 can include an appliance installed between the server(s) 106 and client machine(s) 102. This appliance can mange client/server connections, and in some cases can load balance client connections amongst a plurality of backend servers. The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The computing environment 101 can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS NT, manufactured by Microsoft Corp. of Redmond, Wash., UNIX, LINUX, or SNOW LEOPARD.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; 3G; 4G; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines and cloud reporting tool 220. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include an image processor, a graphics processor or a graphics processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent cloud reporting tool 120, or any portion of the reporting tool. The computing device 100 may further include a storage device 128 that can be either one or more hard disk drives, or one or more redundant arrays of independent disks; where the storage device is configured to store an operating system, software, programs applications, or at least a portion of the cloud reporting tool 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems; the different releases of the Unix and Linux operating systems; any version of the MAC OS manufactured by Apple Computer; OS/2, manufactured by International Business Machines; Android by Google; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook, a tablet; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA); any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; an Android phone; or any other handheld mobile device. Having described certain system components and features that may be suitable for use in the present systems and methods, further aspects are addressed below.

### B. Reporting and Analytics Tool for Cloud Service Applications

The present solution provides multiple inventive aspects directed to the ease of use while maintaining a secure reporting environment that does not impact the integrity, operation and performance of the database. These inventive aspects include but are not limited to the following: i) a secure web service that seamlessly integrates the application environment to the reporting and analytics tool of the present solution, ii) a suggested friendly names engine that helps end users come up with more descriptive and useful names for database fields that may be cryptic and not easy to understand what underlying data they store; (iii) a user interface for easily filtering and grouping data and joining tables that typically requires the user to understand complex structured query language (SQL) expressions; and (iv) a custom view creator that allows user to create views of combination of tables and fields that are not stored in the database but securely and separately with the reporting tool.

Before discussing each of the inventive aspects in detail, a brief description of a secure cloud reporting environment is provided. Referring now to FIG. 2, a block diagram depicting an embodiment of a secure cloud reporting environment is shown. The environment includes a user computing device 202, a client server 210 and a reporting and analytics tool server 220. The user computing device 202, the client server 210 and/or the reporting and analytics tool server 220 can communicate with one another via a network, such as the network 104.

The user computing device 202 can be any computing device, such as the computing device 100 described above. The user computing device 202 can be configured to communicate with the client server 210 and the reporting and analytics tool server 220 via a network. The user computing device 202 can comprise one or more applications, programs, libraries, services, processes, scripts, tasks or any type and form of executable instructions executing on one or more devices, such as servers. The user computing device 202, and any modules or components thereof, may use any type and form of database for storage and retrieval of data. The user computing device 202 may comprise function, logic and operations to perform any of the methods described herein. A user of the user computing device 202 can interact with a web interface of the client server 210 and/or the reporting and analysis tool server 220 to request data from the client server.

The client server 210 can include one or more servers. The client server 210 is configured to communicate with the user computing device 202 and the reporting and analysis tool server 220 via a network, such as the network 104. The client server 210 can comprise one or more applications, programs, libraries, services, processes, scripts, tasks or any type and form of executable instructions executing on one or more devices, such as servers. The client server 210 and any modules or components thereof, may use any type and form of database for storage and retrieval of data. The client server 210 may comprise function, logic and operations to perform any of the methods described herein. In some embodiments, the client server 210 includes a client web server, a client application server, a data storage device that can store one or more databases or data in general, and a reporting service installed on the client server 210.

The client web server is configured to provide a web interface to the user computing device 202. The client web server is configured to receive one or more requests from the user computing device and send responses to the requests. In some implementations, the client web server can be configured to provide the user computing device 202 a web interface through which the user computing device 202 can submit requests for data, including one or more of retrieving, creating, and modifying reports using data stored at the client server.

The client application server can include one or more applications, programs, libraries, services, processes, scripts, tasks or any type and form of executable instructions. The client application server can be configured to perform functions corresponding to requests received from the user computing device. The client application server can be configured to receive instructions from the client web server. In some embodiments, the client application server can receive one or more requests from the reporting and analysis tool server 220 and may be configured to receive and provide data to the reporting and analysis tool server 220. The client application server may be designed, constructed and/or configured to communicate with and/or interface to a plurality of databases. The client application server can receive instructions from the client web server and perform operations using data stored in one or more databases of the client server in response to the received instructions.

The data storage device of the client server 210 may include any type and form of storage or storage service for storing data, for example, in or as databases. In some embodiments, the data storage device is maintained by client server 210. In some embodiments, the data storage device is located local to the client server 210.

The reporting service 212 can include one or more applications, programs, libraries, services, processes, scripts, tasks or any type and form of executable instructions. The reporting service 212 can be configured to perform functions corresponding to requests received from the reporting and analysis tool server 220. The reporting service 212 can be configured to be executed on the client application server. The reporting service can receive instructions from a web server of the reporting and analysis tool server 220. In some embodiments, the reporting service 212 can receive one or more requests from the reporting and analysis tool server 220 and may be configured to receive and provide data to the reporting and analysis tool server 220. In some embodiments, the client application server can receive instructions from the client web server and perform operations on the one or more databases of the client server 210 in response to the received instructions.

The reporting and analysis tool server 220 can include one or more servers. The reporting and analysis tool server 220 is configured to communicate with the user computing device 202 and the client server 210 via a network, such as the network 104. The reporting and analysis tool server 220 can comprise one or more applications, programs, libraries, services, processes, scripts, tasks or any type and form of executable instructions executing on one or more devices, such as servers. The reporting and analysis tool server 220 and any modules or components thereof, may use any type and form of database for storage and retrieval of data. The reporting and analysis tool server 220 may comprise function, logic and operations to perform any of the methods described herein. In some embodiments, the reporting and analysis tool server 220 includes a reporting tool web server, a reporting tool application server and one or more data storage devices that can store one or more databases or data in general.

The reporting tool web server can be configured to exchange data with the client web server of the client server 210. In some embodiments, the reporting tool web server can be configured to provide a web interface to the user computing device 202. The client web server is configured to receive one or more requests from the user computing device and send responses to the requests. In some implementations, the reporting tool web server can be configured to provide the user computing device 202 a web interface through which the user computing device 202 can submit requests for data, including one or more of retrieving, creating, and modifying reports using data stored at the client server 210.

The reporting tool application server can include one or more applications, programs, libraries, services, processes, scripts, tasks or any type and form of executable instructions. The reporting tool application server can be configured to perform functions corresponding to requests received from the user computing device. The reporting tool application server can be configured to receive instructions from the reporting tool web server. In some embodiments, the reporting tool application server can receive one or more requests from the client server and may be configured to receive and provide data to the client server. In some embodiments, the reporting tool application server can receive instructions from the reporting tool web server and perform operations using data stored in one or more databases of the client server in response to the received instructions. The reporting tool application server may be designed, constructed and/or configured to communicate with and/or interface to a plurality of databases. The reporting tool application server can also retrieve store and access data at one or more data storage devices of the reporting tool server 220.

The data storage device of the reporting tool server 220 may include any type and form of storage or storage service for storing data, for example, in or as databases. In some embodiments, the data storage device is located local to the reporting tool server 220. In some embodiments, the data storage device is maintained by reporting tool server 220.

As shown in FIG. 2, in some embodiments, the client server 210 can provide a web interface to the user computing device 202. A user at a user computing device 202 can communicate with the client server 210 and the reporting and analysis tool server 220 via the web interface. In some embodiments, the user computing device 202 can send requests to the client web server of the client server via the web interface. In some embodiments, the client web server can forward the requests to the web server of the reporting and analysis tool server 220. In some embodiments, the reporting and analysis tool server 220 can process the requests received from the user computing device 202. The reporting and analysis tool server 220 can communicate with the application server of the client server 210 via the reporting service 212 of the client server 210. In some embodiments, the reporting and analysis tool server 220 can retrieve data from a database of the client server 210. The data retrieved from the client server can then be manipulated, configured or processed in response to the requests received from the user computing device. In some embodiments, the data retrieved from the client server can be used to generate reports by the reporting and analysis tool server 220. The generated reports can be provided to the user computing device in response to requests from the user computing device. In some embodiments, the reporting and analysis tool server 220 can create views of a database in response to requests from the user computing device. These views can be saved at a data storage device of the reporting and analysis tool server 220.

FIG. 3 is a block diagram of an embodiment of the reporting and analysis tool server 220 shown in FIG. 2. As described above, the reporting and analysis tool server includes one or more applications, programs, libraries, services, processes, scripts, tasks or any type and form of executable instructions executing on one or more devices, such as servers. The reporting and analysis tool server 220 and any modules or components thereof, may use any type and form of database for storage and retrieval of data. The reporting and analysis tool server 220 may comprise function, logic and operations to perform any of the methods described herein. In particular, the reporting and analysis tool server 220 includes a user interface 310, a client server interface 320, details of which are described in Section C, a friendly name suggestion engine 330, details of which are described in Section D, a filter grouping engine 340, details of which are described in Section E and a custom view creation engine 350, details of which are described in Section F.

The user interface 310 can include one or more applications, programs, libraries, services, processes, scripts, tasks or any type and form of executable instructions. The user interface can be configured to communicate with a user computing device, such as the user computing device 202. The user interface can be configured to receive one or more requests from the user computing device 202. The requests can include a request to generate a custom report from one or more tables in the database stored at a client server, such as the client server 210, create custom views from tables of the database, amongst others.

In view of the systems described above, the reporting tool 220 may be a cloud based reporting tool that provides reporting functionality for any type and form of cloud based application or an enterprise application. The user interface may be designed and constructed to provide a seamless integration and user experience for users of the cloud based application or enterprise application to create and run reports on data stored by the cloud based application or enterprise application. In some embodiments, the reporting tool may be accessible via one or more uniform resource locators. For example, the cloud based application or enterprise application may provide one or more of these URLs in their user interface that provide access and present the user interface of the reporting tool. In another example, the reporting tool may comprise APIs, such as web services, that allows the cloud based application or enterprise application to design and constructed a user interface that calls or accesses the functionality of the reporting tool.

### C. Secure Web Service for Seamless Integration

The reporting and analysis tool server 220, generally referred sometimes as reporting tool 220, addresses the challenges of security and integration in offering a cloud based reporting tool. The reporting tool provides secure integration for accessing data in a database remote to the reporting tool, such as from the cloud environment of the reporting tool to the cloud environment of the application. In particular, the application server interface 310 of the reporting and analysis tool server 220 can connect to the database of the application server over a network through a secure web reporting service 212.

In brief overview, the reporting service 212 uses certificates to validate the connection, accepts SQL to run on the connected database and returns a result set. In some embodiments, the reporting service is intentionally lightweight and easy and seamlessly to install. The reporting service controls and securely proxies SQL requests and responses between the reporting and analysis tool server 220 and the database of the application server. As such, the end user of the reporting and analysis tool server 220 cannot write or implement any SQL or other changes to the database that is not approved or authorized by the reporting service. As the reporting service communicates over a secure connection to the reporting and analysis tool server 220, the results from an SQL query are communicated securely to the reporting and analysis tool server 220. As the reporting and analysis tool server 220 may not store any of the data locally and accesses the data from the remote database via the reporting service, such as when a report in run, the reporting and analysis tool server 220 mitigates the risk of and the concern with data being copied or stored outside the database for purposes of reporting. In some embodiments, the reporting and analysis tool 220 may store saved reports, which may include filter and other database values, but which are out of context from the database. As the reporting service controls and limits what SQL queries and database commands that may be run by the reporting and analysis tool server 220, the present solution mitigates the risk of the end user making changes to the database that impacts the operation and performance of the database. Connecting to databases allow users to create custom fields mean that this view creator allows the administrator to run dynamic SQL that builds schemas dynamically.

The reporting service 212 may comprise an application, program, script, library, task, process, service or any type and form of executable instructions. The reporting service may comprise a web service. The reporting service may be designed and constructed to be downloaded and installed. The reporting service may be designed and constructed to be a silent install or an installation without a user interface. The reporting service may comprise functions, operations and logic to provide an interface between the reporting tool and the database. The reporting service may be designed and configured to establish a secure transport layer connection with the application server interface of the reporting tool. The reporting service may be designed and constructed to communicate with the application server interface using secure protocols, such as secure socket layer (SSL) or transport layer security (TLS). The reporting service may be designed and constructed to communicate with the application server interface using secure HyperText Transfer Protocol (HTTPS).

The reporting service may act as a proxy service to the reporting tool to run and execute SQL queries or commands on behalf of the reporting tool against the database of the application server. The reporting service may have a first interface to the reporting tool to receive SQL queries or commands over an application layer protocol, such as HTTP or HTTPs. The reporting service may identify, parse and/or extract SQL queries or commands from the payload of the communications from the reporting tool. The reporting service may have a second interface to communicate and execute the SQL queries or commands to the database. The second interface may be designed and constructed based on the type of the database and the type of interface supported or provided by the database. The reporting service may be configured to login to the database using a predetermined or desired user with certain privileges or access rights.

The reporting service may be designed and constructed to execute a limited set of SQL of all the SQL commands supported by the database. The reporting service may be designed and constructed to not allow, not authorize or prevent the execution of any SQL commands that may change the tables, data or architecture of the database. In some embodiments, the reporting service may only allow read-only type of SQL operations on the database. The reporting service may be designed and constructed to support those types of SQL commands and operations in order to run reports via the reporting tool. The reporting service is also designed and constructed to be flexible enough to allow the SQL necessary to run and obtain dynamic schemas for databases that allow custom fields per client.

The application server interface 310 may be designed and constructed to create, generate or formulate SQL commands or queries and communicate these SQL commands or queries over a network, such as via HTTPS or other application layer protocols, to the reporting service. In some embodiments, the application server interface creates or generates instructions or commands that the reporting service understands for the reporting service, in turn, to create, generate or formulate the desired SQL commands or queries to execute against the database. The application server interface may send such instructions or commands over a network, such as via an application layer protocol The application server interface may communicate with the reporting service responsive to requests by the user in the reporting tool to run or execute a report or otherwise the reporting tool running or executing a report. Based on the data requested in the report, the application server interface generates commands or instructions to the reporting service to obtain the corresponding data.

The application server interface may be designed and constructed to receive and parses responses, such as SQL results, from the reporting service. The application server interface may parse data sets returned from a SQL query and provide the data to the reporting tool to populate an output of a report. The application server interface may parse or identify status of SQL commands or queries from the received response to provide to the reporting tool, which may output via a report. The application server interface may only store such data in memory, such as with the output of the report. The application server interface may store such data in a cache, which is configured to expire within a predetermined time limit. The application server interface may store such until the report is re-executed or until a next request for the same data via the reporting service.

### D. Suggested Friendly Names Engine

The reporting tool 220 also addresses the challenges of creating or designing reports with database schema that may have difficult to understand field names designed for programming components and developers. The field names in a database may not easily identify or describe the data that is stored in the database. In brief overview, Instead of referencing the database field name itself, which may be difficult to parse and recall its underlying data, the friendly name suggestion engine 330 can be configured to allow the end user to reference the more friendly or descriptive name for reports. By using parsing, expression matching and dictionaries, the friendly name suggestion engine 330 may automatically suggest friendly or descriptive aliases for each field name in the database. The user may select a suggested friendly name from an enumerated list of friendly names offered by the reporting tool and use the selected friendly name in place of the database field name for creating reports.

The friendly name suggestion engine 330 include one or more applications, programs, libraries, services, processes, scripts, tasks or any type and form of executable instructions. The friendly name suggestion engine 330 is constructed, designed and/or configured to automatically and intelligently suggest friendly or descriptive names or otherwise aliases for database fields that the user can use for creating reports. The friendly name suggestion engine may be designed and constructed to use regular expressions to match portions of a field name or characters in a field name to a dictionary of words, phrases or terms. The friendly name suggestion engine may be designed and constructed to use rules or policies comprising these regular expression to match portions of field names to entries in a dictionary. The friendly name suggestion engine may be designed and constructed to use rules, policies or regular expression to identify, inspect or determine the content of a field in the database and based on the content to suggest a friendly name, such as via lookup or matching to the dictionary.

In some embodiments, the friendly name suggestion engine 330 can be configured to parse field names of a database to identify one or more common terms. Field names can have names that are somewhat cryptic or esoteric that may not be descriptive of the data they contain. For example, a database field name can include any of the following terms: “fname”; “firstn”; “firstname”; “first name”; “givenname”; “given name”, and “first”. The friendly name suggestion engine 330 can match each of these terms with a descriptive key, for example, “First Name”. In this way, if a request for “First Name” is made or used as an alias or identifier for a database field, values stored under any of the field names “fname”; “firstn”; “firstname”; “first name”; “givenname”; “given name”, and “first” can be retrieved.

In some embodiments, the friendly name suggestion engine 330 parses or identifies words in the field name of compound words specified via underscores, camel case notation or any other predetermined notation having an indicator or separator between compound words. For example, the friendly name suggestion engine 330 may identify underscores between words in a field name of <word1><word2> and suggest a friendly name of “Word1 Word2”. the friendly name suggestion engine 330 may identify CamelCase style of field names such as Word1 Word2 and suggest a friendly name of “Word1 Word2”

In some embodiments, the friendly name suggestion engine 330 can be configured to parse field names and assign a descriptive key to the field name. In some embodiments, the friendly name suggestion engine can be configured to identify values of the field name to identify one or more common terms, strings or expressions. For instance, if the field name is “XYZ” but includes terms, such as “Dave,”; “Chris”, “Michael”, “Robert”, the friendly name suggestion engine 330 can assign a descriptive key of “First Name” to the field name “XYZ” based on the contents of the field name.

The friendly name suggestion engine may determine multiple suggestions for any given field and enumerate a listing of such suggestions via a user interface of the reporting tool. A user may select a desired friendly name from the enumerated list. A user may edit one of the suggestions into a desired form. A user may create a friendly name based on any of the suggestions. In some embodiments, the user may create a friendly name and associate with certain terms or keywords that may be found in a field name or content thereof. Based on this association, the friendly name suggestion engine may store in the dictionary or in any rules or policies to make this suggestion for another field name.

The reporting tool may provide the selected or created friendly name as an alias or otherwise identifier to the corresponding database field in any of the user interface elements used by the user to create and design reports via the reporting tool. The reporting tool maintains the mapping of this friendly name to the corresponding database field, such as in memory or storage of the reporting tool. When running reports, the reporting tool translates the friendly name to the corresponding field name for sending and executing the appropriate SQL command or query.

### E. User Interface for Filtering and Grouping Data

The reporting tool 220 also addresses the challenges of filtering and grouping data across different tables that requires a handle on complex SQL query languages and editing skills that end users do not have. The filter grouping engine 340 provides a user interface that allows users to make complex SQL queries and/or table joins graphically by selecting filters and grouping filters with “and” or “or” logic. As users create filters and groups of filters for reports, the filter grouping engine 340 automatically creates the complex SQL query in the background to get the requested data. Without the user interface of the reporting and analysis tool server 220, report building would require the user to create and/or edit complex SQL queries to use the grouping logic and get the groups as desired.

The filter grouping engine 340 can include one or more applications, programs, libraries, services, processes, scripts, tasks or any type and form of executable instructions. The filter grouping engine 340 is constructed, designed and/or configured to provide a user interface with selectable interface elements and draggable boxes that hides the complexities of SQL in making complex groups with multiple filters using “and” and “or” logic between filters. The filter grouping engine in the background creates and formulates the SQL query to represent the grouping and filtering identified or selected by the user via the user interface, such as the filter selection user interface illustrated in FIG. 4C. The filter grouping engine may create and formulate SQL queries based on select statements using any one or more filters or parameters. The filter grouping engine may create and formulate SQL queries based on joining of tables. The filter grouping engine may create and formulate SQL queries based on any combination of select statements using any one or more filters or parameters and one or more joins and any logical expressions, such as those identified by the user in the filter selection user interface of the reporting tool.

In some embodiments, an end user at the user computing device or end user of the reporting tool can request to create and/or implement specific filters or groups of filters to generate customized reports. The end user may user a simple to use user interface that allows the user to select “and” and “or” logical expressions along with draggable icons representing various field names from various tables to request a filtered set of results from the database. FIG. 4C is a screenshot of a example user interface providing a filter selection user interface with a field selector user interface element. As illustrated, a user can drag and drop icons representing various fields in a database (which may be any friendly names as described above) into filter control user interface element. Responsive to the drag and dropping, the filter selection user interface may automatically include in a group or start a new group or filter. The filter selection user interface may provide a drop down list or other selectable user interface of logical expressions, such as >, <, =, <=, >=etc. to apply to the value of the selected field. The filter selection user interface may provide a user interface field for a user to edit, enter or input a value to apply with the logic of the selected logical expression. The selected field with the logical expression and value may comprise the filter A user may select and add fields to the filter selection user interface and configure the logic and value for the field filter in the filter selection user interface to form a group of any number or combination of filters.

Via the filter selection user interface, a user may select logic between each filter as well as between groups of filters. In some embodiments, a first filter in a group may be configured to have a logical “or” or “and” expression with a second filter in the same group. In some embodiments, a first group of filters may be configured with a logical “or” or “and” with a second group of filters. The filter selection user interface may allow users to drag and drop filters between groups or to drag and drop to change the order of filters in any group. The filter selection user interface may allow users to drag and drop groups of filters to put them in different order. The filter selection user interface provides for group creation via a draggable icon that expands around filter. For example, a user may create multiple filters and the filter selection user interface may display such filters. The user can drag and place a grouping icon or selection element around one or more of those filters to automatically create a group from the dragging and placing.

While the user builds the filter selection, the filter grouping engine 340 may convert the current configuration of the filter selection into an SQL query that can be executed via the reporting service to the remote database. At the time of executing or running the report, the filter grouping engine 340 may convert the current configuration of the filter selection into an SQL query that can be executed via the reporting service to the remote database. The filter grouping engine 340 converts the current configuration of the filter selection into SQL queries by translating each of the elements of the configuration to corresponding SQL elements and queries. The filter grouping engine is designed and constructed to understand the selection and configuration of filters and groups and translate, transform and/or formulate the SQL commands and queries that provide for selection and obtaining of such data from the database. The filter grouping engine is designed and constructed to apply constraints or filters to the data obtained from the database based on the logic and values of each of the filters and groups of filters.

The filter grouping engine may provide the generated or created SQL commands or queries corresponding to the filter selections to the application server interface for communication to the reporting service executing on the remote server to obtain data from the remote database. The reporting service can return results in response to the SQL query. The application server interface may parse the data from the returned results and provide the data as a data for the report. The reporting tool can then provide these results to the end user via the user interface 310 as an output of the report.

### F. Custom View Creator

The reporting tool 220 also addresses the challenges of users who want to create their own tables or views of data but do not have access to the database in order to implement such architecture changes. The custom view creation engine 340 is designed, constructed and/or configured to allow a user, such as an administrator or report writer, to create their own custom views of the data stored in the remote database. For example, an administrator may create one or more custom views that allow the end users to create custom reports from these custom views. The administrator may create these custom views prior to or as part of setting up the report application or prior to end users creating reports. These views may not previously exist in the application's database. For SaaS and cloud based applications, the provider sets up custom views to either obfuscate their database architecture, or extend their database by intelligently grouping data fields without changing their database. For customers with on-premise data, you the local database administrator may create the custom views in the database.

The custom view creation engine 350 is configured to provide a user interface to the end user, such that the end user can create easy to comprehend data entities, such as combination of tables and fields, without having to change the architecture or implementation of the remote database. The remote database stays designed as is and in intact as these custom views are implemented in the report tool to effectively extend the database and application architecture for purposes of reporting.

The custom view creation engine 350 can include one or more applications, programs, libraries, services, processes, scripts, tasks or any type and form of executable instructions. The custom view creation engine 350 is designed, constructed and/or configured to provide a user interface to allow a user to create a custom view, which results in or correspond a query to obtain data from one or more fields of one or more tables or views of the remote database. The custom view may comprise a virtual table based on a SQL query run against the database. For a relational database, a view does not form part of the database schema. The custom view may be a dynamic, virtual table computed or collated from data in the database. Custom views can represent a subset of the data contained in a table. Custom views can join and simplify multiple tables into a single virtual table. Custom views can act as aggregated tables, where the database engine aggregates data (sum, average etc.) and presents the calculated results as part of the data.

The user interface provided by custom view creation engine 350 may allow a user to drag and drop, or otherwise select and/or place different fields from different tables or views existing in the remote database into a custom view container or user interface element provided by the custom view creation engine. The custom view creation engine generates and stores the SQL query for the user configured custom view, such as for example the custom view illustrated in FIG. 4D. The custom view creation engine may generate the corresponding SQL query for the custom view while the view is being built, designed or configured. The custom view creation engine may generate the corresponding SQL query for the custom view upon execution or running of a report that uses or identifies the custom view.

The reporting tool or custom view creation engine 350 may store the custom view and/or corresponding SQL in a storage, such as database, of the reporting tool separate from the remote database. As such, remote database is not aware of or does not have a copy of the custom view. In this manner, the custom view does not change the architecture of the remote database while the user of the reporting tool gets the same benefits of custom views for reporting. The reporting tool or custom view creation engine 350 may store or cache data corresponding to the custom view in the storage of the reporting tool

The reporting service can execute the SQL query and provide the data stored in the database to the custom view creation engine 350. In some embodiments, the reporting service can generate the custom views responsive to receiving the SQL query from the custom view creation engine 350. In some embodiments, the reporting service provides the data required to generate the custom views to the custom view creation engine 350, which the custom view creation engine 350 uses to generate the custom views. The custom view creation engine 350 then provides the generated views to the end user requesting such views. These views can be stored in a database of the reporting and analytics tool 220. Since the reporting service 212 merely accesses data from the database of the client server and does not modify any of the tables or fields of the database, the architecture and contents of the database of the client server remains intact, thereby maintaining the integrity of the data stored. Moreover, the custom view creation engine 350 can use the data received from the database of the client server to create views of one or more tables and fields that can be stored in the database of the reporting and analytics tool 220 for future access.

Referring now to FIGS. 4A through 4I are various screen shots illustrating the easy to use interface for designing and creating reports for a remote database that does not require complex SQL skills and particular skills in SQL or databases.

FIG. 4A is a screenshot of an application management web interface. Through this web interface, a user can create configuration and/or connection information for connecting or communication with a database for an application. A user also provides credentials, such as login information, for authentication purposes.

FIG. 4B is a screenshot of the table and view selection user interface. In this screenshot, the user can select one or more tables and/or views from the tables of a particular database to be used in or by the reporting tool.

FIG. 4C is a screenshot of the filter selection user interface. In this screenshot, an end user can generate custom filters for reports. In particular, the user can select fields to filter in the fields sector portion and select filter parameters in the filter control portion. The boxes around filters that group filters are expandable and draggable to change the grouping. A user can select the draggable box and shrink or expand the box to change the grouping.

FIG. 4D is another screenshot of a user interface for creating a new report. In this screenshot, the end user can Select fields to display as columns in the report.

FIG. 4E is a screenshot showing existing custom views that are draggable via the user interface to generate new views and reports. In this screenshot, existing views, tables, and fields can be selected to create a new view. These existing views, tables and fields may include views, tables and fields stored in the reporting and analytics tool 220 as well as views, tables and fields stored in the database of the client server 210.

FIG. 4F is a screenshot of a graphical view of the relationships between various views, tables and fields of a database. In this screenshot, views, tables and fields that are related to one another are shown by lines. The graphical view shows primary key to foreign key relationships across tables in the schema or database. For example, if two separate views include the same field, for example, field “fname”, then each of the views will include “fname” and lines connecting the two “fname” fields are shown. Via the user interface, the user can define relationships between tables such as via a field of one table to a field of another table. Reports may be generated by the reporting tool based on these defined relationships.

FIG. 4G is a screenshot of a custom view creator tool user interface for managing existing custom views. In this screenshot, an administrator end user can manage (e.g., view, edit or delete) the administrator defined fields of custom view. In this example screenshot, the view name is EMP_SALES corresponding to a report related to administrator defined fields that are employee sales. In addition, the administrator can select to keep the view static or dynamic, in which case the view is periodically updated as new information is stored in the database. In many cases, an administrator dynamically builds custom views for each unique user, which is particularly useful for applications with “custom fields” per client.

FIG. 4H is a screenshot of a web service security tool user interface for managing users authorized to access the application. In this screenshot, a list of authorized users is provided along with their names, contact information and user type. Through this screenshot, one or more users can modify the rights and privileges of these users as well as add new users to the list.

FIG. 4I is a screenshot of a suggested friendly name tool user interface. In this screenshot, the friendly names include “Customer info”, Geo Data“, “Product”, “Product Category” and “Product Subcategory.” Various field names, such as “Address line 1”, “Address line 2”, “BirthDate”, “Commute Distance”, “CustomerKey”, “DateFirstPurchase”, “Email Address”, amongst others are all connected to the friendly name “Customer info”. Similarly, Geo Data includes field names, such as “City”, “CountryRegionCode”, “PostalCode”, amongst others are connected to the friendly name “Geo Data”. Similarly, “Product”, “Product Category” and “Product Subcategory” each have various field names that are connected to each of the “Product”, “Product Category” and “Product Subcategory” respectively.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Having described certain embodiments of the methods and systems, it will now become apparent to one of skill in the art that other embodiments incorporating the concepts of the invention may be used. It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

What is claimed:

1. A system comprising:
A reporting tool, remote to an application, is configured to connect to a database of the application over a network through a secure web service that runs on a server for the application;
wherein the secure web service is configured to use certificates to validate the connection, accept SQL to run on the connected database and return a result set; and
wherein the secure web service is configured to control and securely proxy SQL requests and responses between the reporting tool and the application's database.

2. A system comprising:
a reporting tool, remote to an application, is configured to connect to a database of the application over a network through a secure web service that runs on a server for the application;
a user interface of the reporting tool is configured to enable users via selectable user interface elements and draggable boxes to make complex groups with multiple filters using “and” and “or” logic between filters; and
wherein responsive to the user created filters and groups of filters for reports, the reporting tool is configured to automatically create a complex SQL query in the background to get the requested data.

3. A system comprising:
a reporting tool, remote to an application, is configured to connect to a database of the application over a network through a secure web service that runs on a server for the application
wherein the reporting tool is configured to enable a user to create custom views of data that do not exist in the application's database, without having to change an implementation of the database
